(19) United States
(12) Patent Application Publication
(10) Pub. No.: US 2011/0091615 A1
(43) Pub. Date: Apr. 21, 2011

(54) System and Method for Producing a Reduced-Fat Composition

(75) Inventor: Young C. Kang, Alpharetta, GA (US)

(73) Assignee: WhiteWave Services, Inc., Dallas, TX (US)

(21) Appl. No.: 12/889,183

(22) Filed: Sep. 23, 2010

Related U.S. Application Data
(60) Provisional application No. 61/251,948, filed on Oct. 15, 2009.

(51) Int. Cl. A23L 2/70; A47J 31/00

(52) U.S. Cl. 426/238; 426/490; 426/241; 99/275

(57) ABSTRACT

A reduced fat beverage and a method of making the same is disclosed. A method for making a reduced-fat beverage includes destabilizing a base solution, the base solution comprising a fat component and non-fat components. The method also includes separating the fat component from the non-fat components and removing the fat component from the base solution.

### RELATED APPLICATIONS

This application claims the benefit of priority under 35 U.S.C. §119(e) of U.S. Provisional Application Ser. No. 61/251,948, filed Oct. 15, 2009, and entitled “SYSTEM AND METHOD FOR PRODUCING A REDUCED-FAT COMPOSITION.”

### TECHNICAL FIELD OF THE DISCLOSURE

This invention relates in general to food products and, more particularly, to systems and methods for producing a reduced-fat composition.

### BACKGROUND

The market for low- or reduced-fat beverages, including soy and other nut- or grain-derived liquids is expanding. However, the use of certain ingredients used to make reduced-fat beverages, including soy protein isolate and low-fat soy flour, may result in a finished product that contains undesirable or inferior flavors.

### SUMMARY

In accordance with particular embodiments of the present disclosure, the disadvantages and problems associated with making reduced-fat beverages have been substantially reduced or eliminated.

In accordance with a particular embodiment of the present disclosure, a method for making a reduced fat beverage includes destabilizing a base solution, the base solution comprising a fat component and non-fat components. The method also includes separating the fat component from the non-fat components. Additionally, the method includes removing the fat component from the base solution.

Technical advantages of certain embodiments of the present disclosure include providing a reduced-fat soy milk, almond milk, rice milk, or other beverage. Additionally, embodiments of the present disclosure may be operable to produce a reduced-fat soy milk without using a soy protein isolate or low-fat soy flour, each of which may include undesirable tastes or flavor characteristics. Additionally, embodiments of the present disclosure may be operable to demulsify and/or separate oil from a base solution without using chemical demulsifying additives. Thus, embodiments of the present disclosure may provide for a reduced-fat beverage that includes the nutritional and flavor profile of full-fat beverages. As a result, the present disclosure provides numerous technical advantages.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates an embodiment of the present disclosure, including a base solution, a sonicator, a microwave, and a centrifuge; and

FIG. 2 is a flow chart illustrating a method for making a reduced-fat organically-derived beverage in accordance with a particular embodiment of the present disclosure.

### DETAILED DESCRIPTION

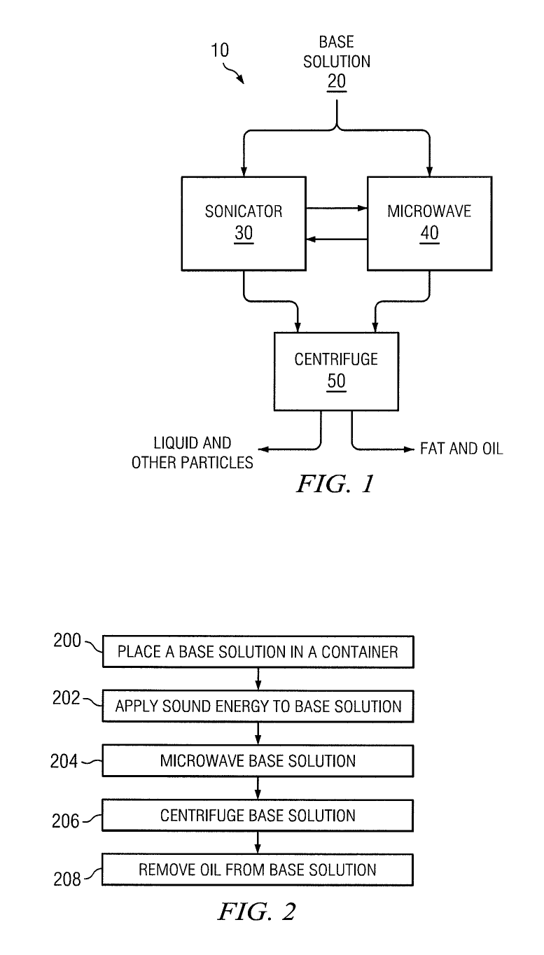

FIG. 1 illustrates a particular embodiment of a system 10 for making a reduced-fat beverage. System 10 may include sonicator 30, microwave 40, and centrifuge 50. In general, sonicator 30 may apply sound waves to a base solution 20. Additionally, microwave 40 may apply microwaves to base solution 20. Either or both of these processes may destabilize oil in base solution 20. The destabilized base solution 20 may be centrifuged in centrifuge 50, whereby the oil is separated from the oil-in-water emulsion.

Base solution 20 may represent any emulsified solution suitable for human consumption. In particular embodiments, base solution 20 may represent any plant-derived emulsified solution, including, but not limited to, soy milk, almond milk, rice milk, or coconut milk. Base solution 20 may be formed by fine-grinding a raw ingredient, (such as, for example, soy beans or almonds) into a paste or powder, to which water or other liquid is added. For example, soy beans may be ground at an appropriate temperature and under appropriate conditions. The ground soy beans may then be added to water or other liquid. The ground soy bean and water mixture may be mixed thoroughly together to suspend the ground soy bean particles in the water or other liquid. The final mixed solution may be referred to as soy milk. Due to oils present in the raw ingredient, such as soy bean oils, the base solution 20 may contain a certain amount of oil as an oil-in-water emulsion.

Sonicator 30 may represent any machine or device operable to generate sound energy. Sound energy may include, but is not limited to, ultrasound waves. In particular embodiments, base solution 20 may be placed in a container that is placed in a water bath. In other embodiments sonicator 30 may apply sound waves to base solution 20 as base solution 20 is being conveyed through hoses, pipes or tubes between or among various components of system 10. In such embodiments, sound waves may be able to penetrate the pipes conveying based solution 20 to destabilize the oil in base solution 20. Sonicator 30 may generate sound energy at a predetermined frequency for a predetermined time as base solution 20 is at a predetermined temperature which agitates oil in base solution 20 (a process which may be referred to as “sonicating”). For example, in particular embodiments of system 10, base solution 20 may be subjected to ultrasonic waves for thirty minutes. Additionally, the water used by sonicator 30 and/or base solution 20 may have a temperature of approximately between one (1) and one hundred (100) degrees Celsius. In particular embodiments, the water used by sonicator 30 and/or base solution 20 may have a temperature of approximately seventy (70) degrees Celsius. In general however, the water used by sonicator 30 and/or base solution 20 may have any appropriate temperature suitable to perform the described functionality. As a result, sonicator 30 may destabilize oil in base solution 20. In particular embodiments, oil in base solution 20 may become at least partially or substantially demulsified after sound energy is applied by sonicator 30.

Microwave 40 may represent any device or machine operable to generate microwave energy. In particular embodiments, base solution 20 may be placed in a container that is then placed in microwave 40 and irradiated by microwave energy generated by microwave 40. In other embodiments microwave 40 may apply microwave energy to base solution 20 as base solution 20 is being conveyed through pipes or tubes between or among various components of system 10. In such embodiments, microwave energy may be able to penetrate the pipes conveying base solution 20 to agitate the oil in base solution 20. Microwave 40 may generate microwave energy at a predetermined frequency and/or intensity for a predetermined period of time. For example, microwave 40 may generate microwave energy for a time approximately between one (1) second and five (5) minutes. In particular embodiments, base solution 20 may be subjected to microwave energy for approximately ninety (90) seconds. In other embodiments, base solution 20 may be subjected to microwave energy for approximately (10) seconds. In general, however, microwave 40 may apply microwaves to base solution 20 in any appropriate manner. As a result, microwave 40 may destabilize oil in base solution 20. Thus, microwave 40 may at least partially or substantially demulsify oil in base solution 20.

Centrifuge 50 may separate demulsified oil from other non-fat components of base solution 20. In particular embodiments, centrifuge 50 includes separate, individualized compartments into which portions of base solution 20 are placed. Centrifuge 50 may centrifuge or centrifugalize the relevant portions of base solution 20 for a predetermined time at a predetermined revolutions per minute. In particular embodiments, centrifuge 50 may rotate base solution 20 at approximately 10,000 revolutions per minute for approximately one minute. However, centrifuge 50 may operate at a substantially higher or lower number of revolutions per minute, including from 1000 to 20,000 revolutions per minute. In other embodiments, centrifuge 50 may include a single tank or compartment in which base solution 20 is placed. In such embodiments, centrifuge 50 may operate continuously. For example, base solution 20 may be inserted into centrifuge 50 as separated oil and other components separately discharged through one or more outlets. The particular number of revolutions per minute at which centrifuge 50 operates may be configured according to the particular base solution 20 used, the desired resulting fat content of the finished product, and/or the overall capabilities of system 10.

In operation, an operator of system 10 places base solution 20 in a jar, beaker, or other suitable container. As noted above, base solution 20 may comprise any emulsified solution, including, but not limited to a plant-derived emulsified solution. For purposes of this example, the following described operation assumes a soy-derived solution, commonly referred to as soy milk.

Once base solution 20 is placed in a jar, beaker, or other suitable container, an operator of system 10 may place base solution 20 in a water bath associated with sonicator 30. As noted above, sonicator 30 may apply sound energy at an appropriate frequency for a predetermined amount of time. For example, sonicator 30 may apply sound energy (which may include ultrasound waves) to base solution 20 for thirty (30) minutes while the water and/or base solution 20 is at a temperature of approximately seventy (70) degrees Celsius. In general however, as noted above, sonicator 30 may apply sound energy to base solution 20 for any appropriate amount of time at any appropriate temperature. Sonicator 30 may cause or facilitate at least the partial demulsifying of oil from base solution 20.

Additionally, base solution 20 may be placed in microwave 40 and microwaved for a predetermined amount of time. As discussed above, base solution 20 may be microwaved in microwave 40 for approximately 90 seconds. Particular embodiments of system 10 may include base solution 20 being microwaved for substantially more or substantially less time than 90 seconds. Microwave energy may cause or facilitate the demulsifying of oil from base solution 20. As a result, by microwaving and/or sonicating base solution 20, base solution 20 may be demulsified without using chemical demulsifying additives, such as, for example, Phenolformaldehyde Ethoxylated Alcohol, Lecithin, Mono-Glyceride, Di-Glyceride, Polysorbate 20, or Polysorbate 60. Additionally, as indicated by arrows in FIG. 1, particular embodiments of system 10 may include either sonicating base solution 20 or microwaving base solution 20, or both sonicating base solution 20 and microwaving base solution 20. In embodiments of system 10 in which base solution 20 is both sonicated and microwaved, base solution may be sonicated and then microwaved, or microwaved and then sonicated. The particular order of operations may depend on the particular base solution 20 used, the particular microwave 40 and centrifuge 50 used, and/or any other appropriate considerations, variables, or factors.

Once base solution 20 is sonicated in sonicator 30 and/or microwaved in microwave 40, base solution 20 may be centrifuged in centrifuge 50. As discussed above, centrifuge 50 may separate destabilized oil from water or other components of base solution 20. In particular embodiments, centrifuge 50 may operate continuously. For example, centrifuge may receive microwaved and/or sonicated base solution 20 from one or more inlets while base solution 20 and/or oil that has been separated from base solution 20 are discharged through one or more separate outlets. In such embodiments, centrifuge 50 may have outlets located near an upper region of centrifuge 50 to remove oil as it becomes separated from water and other components of base solution 20. As a result, oil may be removed from base solution 20.

Additionally, in particular embodiments of system 10, the process described above may be partially or fully automated. For example, one or more hoses, pipes, tubes or other conveyance mechanisms may convey base solution 20 between or among various components of system 10. An operator may place base solution 20 in a container, from which base solution 20 is conveyed through a conveyance mechanism to sonicator 30 and/or microwave 40. Sonicator 30 and/or microwave 40 may be located external to the conveyance mechanism, and may transmit sound waves and/or microwaves towards the conveyance mechanism. The relevant sound waves or microwaves may penetrate the conveyance mechanism to destabilize base solution 20 as base solution 20 flows through the conveyance mechanism. In particular embodiments, system 10 may be configured such that base solution 20 passes through sonicator 30 and/or microwave 40 one or more times in order to sufficiently destabilize oil in base solution 20. After being sonicated and/or microwaved, base solution 20 may be conveyed to centrifuge 50. As discussed above, centrifuge 50 may be operable to receive a particular portion of base solution 20 as it concurrently discharges separated oil and other components of another particular portion of base solution 20. Particular embodiments of system 10 may allow an operator of system 10 to control the flow rate of base solution 20 through a conveyance mechanism between or among various components of system 10 to control the percentage of oil in base solution 20 removed by centrifuge and/or to control the overall amount of reduced-fat composition produced by system 10. In general, the processes described above may allow system 10 to operate in batches, semi-continuously, or continuously depending on the configuration of the various elements within system 10 and the desires of an operator of system 10.

By sonicating and/or microwaving base solution 20, and centrifuging the resulting sonicated and/or microwaved base solution 20, system 10 may produce a reduced-fat beverage. In particular embodiments, system 10 may be operable to produce a reduced-fat soy milk, almond milk, rice milk, or other similar nut- or grain-derived beverage. Additionally, system 10 may be operable to produce a reduced-fat soy milk without using a soy protein isolate or low-fat soy flour, each of which may include undesirable tastes or flavor characteristics. Additionally, system 10 may be operable to demulsify and/or separate oil in an oil-in-water emulsion without using chemical demulsifying additives. Thus, system 10 may provide for a reduced-fat, beverage that includes the nutritional and flavor profile of full-fat beverages. As a result, system 10 may include numerous operational benefits. Nonetheless, particular embodiments may provide some, none, or all of these benefits and may provide additional benefits.

FIG. 2 is a flow diagram illustrating example operation of a particular embodiment of system 10. Operation, in the illustrated example begins at step 200 with an operator of system 10 placing base solution 20 in a jar, beaker, or other suitable container. As noted above, base solution 20 may comprise any emulsified solution, including, but not limited to nut- or grain-derived emulsified solutions, or a blend of one or more nut- or grain-derived emulsified solutions. For purposes of example, FIG. 2 illustrates an embodiment of system 10 in which the emulsified solution is a soy-derived solution, such as soy milk.

At step 202, sonicator 30 may apply sound energy to base solution 20 to destabilize oil in base solution 20. In particular embodiments, base solution 20 may be placed in a water bath associated with sonicator 30. As noted above, sonicator 30 may be operable to apply sound energy at an appropriate frequency for a predetermined amount of time. For example, sonicator 30 may apply sound energy for approximately between one (1) second to thirty (minutes) with base solution at a temperature of between approximately one (1) degree Celsius to one hundred (100) degrees Celsius. In particular embodiments, sonicator 30 may apply sound energy to base solution 20 for approximately 30 minutes while the water and/or base solution 20 is at a temperature of approximately seventy (70) degrees Celsius. In general, however, as noted above, sonicator 30 may apply sound energy to base solution 20 for any appropriate amount of time at any appropriate temperature. Sonicator 30 may cause or facilitate at least partial demulsifying of oil from base solution 20.

At step 204, base solution 20 may be placed in microwave 40 and microwaved for a predetermined amount of time. As discussed above, base solution 20 may be microwaved in microwave 40 for approximately ninety (90) seconds. In general, however, base solution 20 may be microwaved for substantially more or substantially less time than ninety (90) seconds. In particular embodiments, microwave 40 may apply microwaves to base solution 20 for ten (10) seconds. Microwave energy may destabilize oil in base solution 20, and may cause or facilitate at least the partial demulsifying oil from base solution 20. As a result, by microwaving and/or sonicating base solution 20, base solution 20 may be demulsified without using chemical demulsifying additives. Additionally, particular embodiments of system 10 may include either sonicating base solution 20 in step 202 or microwaving base solution 20 in step 204, or both sonicating base solution 20 in step 202 and microwaving base solution 20 in step 204. In particular embodiments, step 204 may be performed before step 202. The particular order of operations may depend on the particular base solution 20 used, the particular sonicator 30, microwave 40 and/or centrifuge 50 used, and/or any other appropriate considerations, variables, factors.

In step 206, base solution 20 may be centrifuged in centrifuge 50. As discussed above, centrifuge 50 may separate destabilized and/or demulsified oil from water or other components of base solution 20. Oil in an oil-in-water emulsion may rise to a relative upper portion of base solution 20 while water and other components of base solution 20 may sink to a relative lower portion of base solution 20. In particular embodiments, centrifuge 50 may receive microwaved and/or sonicated base solution 20 from one or more inlets while separated oil and other components of base solution 20 are discharged through one or more separate outlets. In such embodiments, centrifuge 50 may have piping located near an upper region of centrifuge 50 to remove oil as it becomes separated from other components of base solution 20.

In step 208, oil may be removed from base solution 20. In particular embodiments, substantially all destabilized and separated oil is removed from base solution 20. In general, however, any appropriate portion of oil may be removed. In particular embodiments, the amount of fat removed from base solution 20 may be controlled by an operator of system 10 by controlling the flow rate of base solution 20 into and/or out of centrifuge 50, and/or by controlling the number of revolutions per minute at which centrifuge 50 rotates base solution 20. As a result, oil may be removed from base solution 20 to make a beverage containing a desired percentage of fat. For example, particular embodiments of the described techniques may be utilized to produce a beverage or other composition having a fat content ranging from approximately 0% to 10% fat.

The steps illustrated in FIG. 2 may be combined, modified, or deleted where appropriate, and additional steps may also be added to those shown. Additionally, the steps may be performed in any suitable order without departing from the scope of the present disclosure.

Although the present disclosure has been described with several embodiments, numerous changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A method for making a reduced-fat beverage, comprising:
destabilizing a base solution, the base solution comprising a fat component and non-fat components;
separating the fat component from the non-fat components; and
removing the fat component from the base solution.

2. The method of claim 1, wherein destabilizing the base solution comprises sonicating the base solution.

3. The method of claim 2, wherein sonicating the base solution comprises sonicating the base solution for approximately between one second and thirty minutes, wherein the base solution has a temperature of approximately between one degree Celsius and one hundred degrees Celsius.

4. The method of claim 2, wherein sonicating the base solution comprises sonicating the base solution in an ultrasonic water bath for 30 minutes, wherein the water bath has a temperature approximately equal to 70 degrees Celsius.

5. The method of claim 1, wherein destabilizing the base solution comprises applying microwaves to the base solution.

6. The method of claim 1, wherein separating the fat component from the non-fat components comprises centrifuging the base solution.

7. The method of claim 1, wherein the base solution comprises soy, almond, rice, or coconut.

8. The method of claim 1, wherein the destabilizing the base solution comprises destabilizing the base solution without adding a chemical demulsifier.

9. The method of claim 1, wherein the destabilizing the base solution comprises sonicating the base solution and applying microwaves to the base solution.

10. The method of claim 1, wherein:
the separating the fat component further comprises:
introducing the base solution into a centrifuge at a pre-determined flow rate; and
centrifuging the solution at a pre-determined number of revolutions per minute;
wherein the flow rate and the number of revolutions per minute are selected to reduce the fat content of the base solution to a level less than approximately 10%; and
the removing the fat component from the base solution further comprises:
discharging the removed fat component through an outlet of the centrifuge; and
discharging the non-fat components through a separate outlet of the centrifuge.

11. A system, comprising:
a sonicator operable to:
destabilize a base solution, the base solution comprising a fat component and non-fat components; and
a centrifuge operable to:
separate the fat component from the non-fat components; and
remove the fat component from the base solution.

12. The system of claim 11, the sonicator operable to destabilize the base solution by sonicating the base solution for approximately between one second and thirty minutes, wherein the base solution has a temperature of approximately between one degree Celsius and one hundred degrees Celsius.

13. The system of claim 11, the sonicator operable to destablize the base solution by sonicating the base solution in an ultrasonic water bath for 30 minutes, wherein the water bath has a temperature approximately equal to 70 degrees Celsius.

14. The system of claim 11, further comprising a microwave generator operable to destabilize the base solution by applying microwave energy to the base solution.

15. The system of claim 11, the centrifuge operable to separate the fat component from the non-fat components by centrifuging the base solution at a rate approximately between 1,000 and 20,000 revolutions per minute.

16. The system of claim 11, wherein the base solution comprises soy, almond, rice, or coconut.

17. The system of claim 11, wherein the base solution is substantially free of chemical demulsifiers.

18. The system of claim 11, further comprising a microwave generator operable to destabilize the base solution by applying microwave energy to the base solution, the microwave energy applied for a time period less than approximately five minutes.

19. The system of claim 11, the centrifuge further comprising:
an inlet operable to introduce the base solution into the centrifuge at a pre-determined flow rate;
a first outlet operable to discharge the removed fat component; and
a second outlet operable to discharge the non-fat components.

20. The system of claim 11, the centrifuge operable to separate the fat component from the non-fat components by centrifuging the base solution at a pre-determined number of revolutions per minute, the number of revolutions per minute selected to reduce the fat content of the base solution to a level less than approximately 10%.
